(19) United States
(12) Patent Application Publication
(10) Pub. No.: US 2014/0348037 A1
(43) Pub. Date: Nov. 27, 2014

(54) METHOD FOR UPDATING SYSTEM INFORMATION, ACCESS NETWORK EQUIPMENT AND USER EQUIPMENT

(71) Applicant: Huawei Technologies Co., Ltd., Shenzhen (CN)

(72) Inventors: Fei YANG, Shenzhen (CN); Xin XIONG, Shenzhen (CN); Yue LI, Shenzhen (CN); Song ZHU, Shenzhen (CN); Bin ZHEN, Shenzhen (CN)

(21) Appl. No.: 14/336,474

(22) Filed: Jul. 21, 2014

Related U.S. Application Data
(63) Continuation of application No. PCT/CN2013/070751, filed on Jan. 21, 2013.

(30) Foreign Application Priority Data
Jan. 21, 2012 (CN) 201210019878.0

(51) Int. Cl. H04W 48/10; H04L 5/16; H04L 5/00

(52) U.S. Cl. CPC H04W 48/10; H04L 5/0053; H04L 5/16; H04W 88/12
USPC 370/280; 370/312

(57) ABSTRACT

Embodiments of the present invention provide a method for updating system information, an access network equipment, and a user equipment. Embodiments of the present invention can avoid the problem that, in the prior art, the user equipment is unable to correctly receive updated system information in that a subframe, configured by the user equipment supporting a half duplex data transmission mode in a system information receiving window corresponding to updated system information, may include an uplink subframe, or may further include an idle subframe, thus enhancing reliability of acquiring system information and reliability of data transmission.

### CROSS-REFERENCE TO RELATED APPLICATIONS

The application is a continuation of International Patent Application No. PCT/CN2013/070751, filed on Jan. 21, 2013, which claims priority to Chinese Patent Application No. 201210019878.0, filed on Jan. 21, 2012, both of which are hereby incorporated by reference in their entireties.

### TECHNICAL FIELD

The present invention relate to communications technology, especially to a method for updating system information, an access network equipment, and a user equipment.

### BACKGROUND

In the wireless communications system, duplex data transmission modes can be classified into two types: one is a half duplex data transmission mode allowing data to be transmitted in two directions, nevertheless, it only allows data to be transmitted in one direction at a given time; the other is a full duplex data transmission mode allowing data to be transmitted in two directions in the meantime.

When system information is needed for updates, an access network equipment can indicate the updated system information to a user equipment (User Equipment, abbreviated as a UE) supporting a variety of data transmission modes. As for a user equipment supporting the full duplex data transmission mode, the user equipment can receive the system information in all system information receiving windows according to the above indication; as for a user equipment supporting the half duplex data transmission mode, if all subframes of the user equipment in the system information receiving window corresponding to the updated system information are configured as downlink subframes, the user equipment may likewise receive the updated system information according to the above indication.

Nevertheless, a configured subframe of the user equipment supporting the half duplex data transmission mode in the system information receiving window corresponding to the updated system information, may include an uplink subframe, or may further include an idle subframe. Under such circumstances, the user equipment may be unable to correctly receive the updated system information, thus be unable to perform successive data transmission in light of the updated system information, and resulting in reliability reduction of acquiring system information and reliability reduction of data transmission.

### SUMMARY

The present invention provides a method for updating system information, an access network equipment, and a user equipment to enhance reliability of acquiring system information and reliability of data transmission.

According to one aspect, a method for updating system information includes:

determining, by an access network equipment, updated system information; and

broadcasting, by the access network equipment, indication information, where the indication information is configured to indicate an identifier of the updated system information so that, in a system information window corresponding to the identifier, a user equipment receives the updated system information transmitted by the access network equipment.

According to another aspect, a method for updating system information includes:

receiving, by a user equipment, indication information broadcasted by an access network equipment, wherein the indication information is configured to indicate an identifier of updated system information; and

receiving, by the user equipment, the updated system information transmitted by the access network equipment, in a system information window corresponding to the identifier.

According to another aspect, an access network equipment includes:

a determining unit, configured to determine updated system information; and

a broadcasting unit, configured to broadcast indication information, where the indication information is configured to indicate an identifier of the updated system information determined by the determining unit so that, in a system information window corresponding to the identifier, a user equipment receives the updated system information transmitted by the access network equipment.

According to another aspect, a user equipment includes:

an indication receiving unit, configured to receive indication information broadcasted by an access network equipment, where the indication information is configured to indicate an identifier of updated system information; and

an information receiving unit, configured to receive the updated system information transmitted by the access network equipment in a system information window corresponding to the identifier being indicated by the indication information received by the indication receiving unit.

It can be seen from the aforementioned technical solutions that embodiments of the present invention can avoid the problem that, in the prior art, the user equipment is unable to correctly receive updated system information in that a configured subframe of the user equipment supporting a half duplex data transmission mode, in a system information receiving window corresponding to updated system information, may include an uplink subframe, or may further include an idle subframe, thus enhancing reliability of acquiring system information and reliability of data transmission.

### BRIEF DESCRIPTION OF DRAWINGS

In order to illustrate the technical solution of the embodiments of the present invention or in prior art more clearly, drawings needed for describing the embodiments and the prior art are briefly introduced hereinafter. Apparently, the drawings being described hereinafter are only some embodiments of the present invention, and persons having ordinary skill in the art may still derive other drawings from the accompanying drawings without creative efforts.

FIG. 1 is a schematic flow diagram of a method for updating system information according to an embodiment of the present invention;

FIG. 2 is a schematic flow diagram of a method for updating system information according to another embodiment of the present invention;

FIG. 3 is a schematic block diagram of an access network equipment according to another embodiment of the present invention;

FIG. 4 is a schematic block diagram of a user equipment according to another embodiment of the present invention;

FIG. 5 is a schematic block diagram of a user equipment according to another embodiment of the present invention.

### DESCRIPTION OF EMBODIMENTS

For the purpose of better clarifying the objectives, technical solutions and advantages in embodiments of the present invention, the following clearly and comprehensively describes the technical solutions in embodiments of the present invention with reference to the accompanying drawings of embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

The technology solutions of the present invention may be applied to a variety of wireless communications systems, such as a global system for mobile communications (Global System for Mobile communications, abbreviated as GSM) system, a general packet radio service (General Packet Radio Service, abbreviated as GPRS) system, a code division multiple access (Code Division Multiple Access, abbreviated as code division multiple access) system, a wideband code division multiple access (Wideband Code Division Multiple Access, abbreviated as WCDMA) system or a long term evolution (Long Term Evolution, abbreviated as LTE) system, etc.

Wherein, an access network equipment may be a base station controller (Base Station Controller, abbreviated as BSC) in a GSM system, a GPRS system or a CDMA system, a radio network controller (Radio Network Controller, abbreviated as RNC) in a WCDMA system, or an evolved node B (Evolved Node B, abbreviated as eNB or eNodeB) in a LTE system.

The duplex data transmission mode according to the present invention can either be a frequency division duplexing (Frequency Division Duplexing, abbreviated as FDD) data transmission mode or a time division duplexing (Time Division Duplexing, abbreviated as TDD) data transmission mode. The present invention shall not confine it.

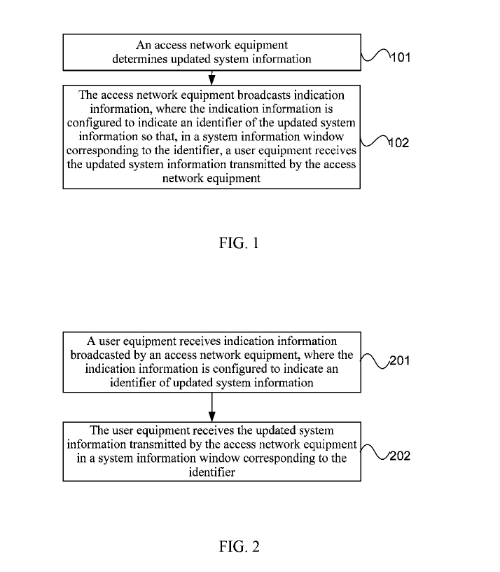

FIG. 1 is a schematic flow diagram of a method for updating system information according to an embodiment of the present invention. As shown in FIG. 1, the method for updating system information according to this embodiment may include:

101, An access network equipment determines updated system information; and

102, The access network equipment broadcasts indication information, where the indication information is configured to indicate an identifier of the updated system information so that, in a system information window corresponding to the identifier, a user equipment receives the updated system information transmitted by the access network equipment.

According to an optional implementation mode of the present invention, the above access network equipment may broadcast a paging message, where the above paging message includes the above indication information.

According to the present embodiment, after the access network equipment determines the updated system information, by means of the above access network equipment's broadcasting the indication information, the above indication information is used to indicate an identifier of the above updated system information, so that the user equipment can receive the above updated system information transmitted by the access network equipment in the system information window corresponding to the above identifier, which is capable of avoiding problems that the user equipment is unable to correctly receive the updated system information in that, in the prior art, the subframe in the system information receiving window corresponding to the updated system information, configured by the user equipment supporting the half duplex data transmission mode, may include the uplink subframe or further include the idle subframe, thus enhancing reliability of acquiring system information and reliability of data transmission.

FIG. 2 is a schematic flow diagram of a method for updating system information according to another embodiment of the present invention, as shown in FIG. 2, the method for updating system information according to the present embodiment may include:

201, a user equipment receives indication information broadcasted by an access network equipment, where the indication information is configured to indicate an identifier of updated system information;

According to an optional implementation mode, the above user equipment may receive a paging message broadcasted by the access network equipment, where the paging message includes the indication information.

202, the user equipment receives, in a system information window corresponding to the identifier, the updated system information transmitted by the access network equipment.

According to an optional implementation mode, the above user equipment can determine an uplink subframe being included, or, an uplink subframe and an idle subframe being included in the system information window corresponding to the identifier; then, the user equipment updates and configures the uplink subframe, or, the above uplink subframe and idle subframe to a downlink subframe; lastly, the user equipment receives, on all subframes in the system information window corresponding to the identifier, the updated system information transmitted by the access network equipment.

Furthermore, in order not to influence uplink data transmission and downlink data transmission of the user equipment supporting a full duplex data transmission mode, only when the user equipment is the one supporting a half duplex data transmission mode can it carry out determining the uplink subframe being included, or the uplink subframe and the idle subframe being included, in the system information window corresponding to the identifier.

According to the present embodiment, by means of the user equipment's receiving the indication information broadcasted by the access network equipment, the above indication information is used to indicate the identifier of the updated system information, so that the user equipment can receive, in the system information window corresponding to the identifier, the updated system information transmitted by the above access network equipment, which is capable of avoiding problems that the user equipment is unable to correctly receive the updated system information in that, in the prior art, the subframe in the system information receiving window corresponding to the updated system information, configured by the user equipment supporting the half duplex data transmission mode, may include the uplink subframe or further include the idle subframe, thus enhancing reliability of acquiring system information and reliability of data transmission.

In addition, according to another embodiment of the present invention, after the above user equipment receives, on all subframes in the system information window corresponding to the above identifier, the above updated system information transmitted by the access network equipment, the user equipment can further restore and configure the updated and configured downlink subframe to the uplink subframe, or to the uplink subframe and the idle subframe, so as to reduce influence on the data transmission efficiency for the user equipment as much as possible.

In order to better clarify the method provided by the embodiment of the present invention, next a LTE system will be exemplified. In a LTE system, the maximum number of pieces of system information (System Information, abbreviated as SI) is 12, where each SI may consist of one or more system information block(s) (System Information Block, abbreviated as SIB). In the LTE system, the number of SIBs capable of being mapped onto SI is 12, i.e., SIB2˜SIB13. If each SI is consisted of one SIB, the indication information can be represented as a 12 bits bitmap, where each U bit in the bitmap may correspond to one SI, such as: the highest bit represents SI1, and so on, the lowest bit represents SI12; 1 represents update, 0 represents not update, i.e., U_{SI1} U_{SI2} U_{SI3} U_{SI4} U_{SI5} U_{SI6} U_{SI7} U_{SI8} U_{SI9} U_{SI10} U_{SI11} U_{SI12}; if each SI is consisted of two SIBs, the indication information can be represented as a 6 bits bitmap, where each U bit in the bitmap may correspond to one SI, such as: the highest bit represents SI1, and so on, the lowest bit represents SI6; 1 represents update, 0 represents not update, i.e., U_{SI1} U_{SI2} U_{SI3} U_{SI4} U_{SI5} U_{SI6}. By the above indication information, it is possible to indicate which system information is updated.

Postulate that each SI is consisted of one SIB. When an eNodeB determines the updated system information, i.e., determines SI2 and SI4 is updated, the eNodeB may broadcast a paging message, wherein the paging message includes indication information, i.e., 010100000000. After the UE receives the indication information broadcasted by the eNodeB, when the UE is a user equipment supporting a half duplex data transmission mode, the UE is capable of determining whether a uplink subframe, or a uplink subframe and an idle subframe are included in the system information window corresponding to the above identifier. If the UE has determined the system information window corresponding to the above identifier includes the uplink subframe, or includes the uplink subframe and the idle subframe, it is possible to update and configure the uplink subframe, or the uplink subframe and the idle subframe as a downlink subframe, and receive the above updated system information, i.e., SI2 and SI4, transmitted by the eNodeB on all subframes (after updates and configuration) in the system information window corresponding to the above identifier.

Hitherto, in the above LTE system, the subframe configured in the system information receiving window corresponding to the updated system information by the UE supporting the half duplex data transmission mode may include the uplink subframe, or may further include the idle subframe. Under such circumstances, the UE supporting the half duplex data transmission mode may update and configure the uplink subframe, or the uplink subframe and the idle subframe as the downlink subframe, so that the UE can receive the updated system information on all subframes in the system information receiving window corresponding to the updated system information, thus being capable of performing subsequent data transmission according to the updated system information and efficiently enhancing reliability of acquiring system information and reliability of data transmission. In the meantime, the UE supporting the full duplex data transmission mode may as well continue performing the receipt of the updated system information in accordance with the method in the prior art, which will not influence the data transmission efficiency of the UE supporting the full duplex data transmission mode.

It should be noted: in view of each previously mentioned method embodiment, they are all being described as a series of action combinations for simplifying the description, however, a person having ordinary skill in the art shall notice the present invention does not confine to the action sequence being described in that, in light of the present invention, certain steps may adopt other sequences or proceed in parallel. Besides, a person having ordinary skill in the art shall likewise understand that the embodiments being described in the description all belong to preferable embodiments, and the actions and models involved are not necessary for the present invention.

According to the above embodiments, the description for each embodiment has its own emphasis. For a part not detailed in a certain embodiment, it is possible to refer to corresponding description in other embodiments.

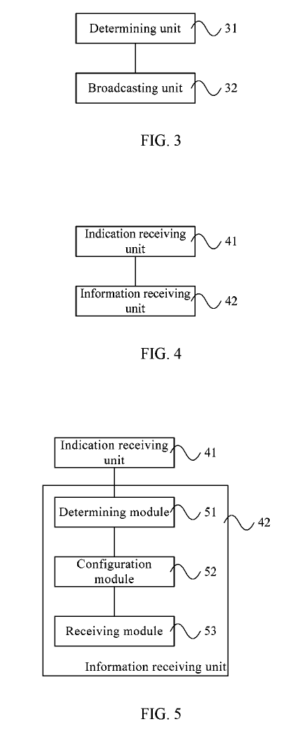

FIG. 3 is a schematic block diagram of an access network equipment according to another embodiment of the present invention. As shown in FIG. 3, the access network equipment according to the present embodiment may include a determining unit 31 and a broadcasting unit 32. Where, the determining unit 31 is configured to determine updated system information; the broadcasting unit 32 is configured to broadcast indication information, where the indication information is configured to indicate an identifier of the updated system information determined by the determining unit 31, so that, in a system information window corresponding to the above identifier, a user equipment can receive the updated system information transmitted by the access network equipment.

According to one optional implementation mode of the present invention, the broadcasting unit 32 may broadcast a paging message, where the paging message includes the above indication information.

According to the embodiment, after the determining unit has determined the updated system information, the broadcasting unit broadcasts the indication information which is configured to indicate the identifier of the updated system information determined by the determining unit, so that the user equipment can receive the updated system information transmitted by the access network equipment in the system information window corresponding to the identifier, which is capable of avoiding problems that the user equipment is unable to correctly receive the updated system information in that, in the prior art, the subframe, configured by the user equipment supporting the half duplex data transmission mode in the system information receiving window corresponding to the updated system information, may include the uplink subframe or further include the idle subframe, thus enhancing reliability of acquiring system information and reliability of data transmission.

FIG. 4 is a schematic block diagram of a user equipment according to another embodiment of the present invention. As shown in FIG. 4, the user equipment according to the present embodiment may include an indication receiving unit 41 and an information receiving unit 42. Wherein, the indication receiving unit 41 is configured to receive the indication information broadcasted by the access network equipment, and the indication information is configured to indicate the identifier of the updated system information; the information receiving unit 42 is configured to receive the updated system information transmitted by the access network equipment in a system information window corresponding to the identifier being indicated by the indication information received by the indication receiving unit 41.

According to one optional implementation mode of the present invention, the indication receiving unit 41, in particular, may receive a paging message broadcasted by the access network equipment, where the paging message includes the indication information.

According to one optional implementation mode of the present invention, as shown in FIG. 5, the information receiving unit 42 may include:

a determining module 51, configured to determine an uplink subframe, or, an uplink subframe and an idle subframe, being included in the system information window corresponding to the identifier;

a configuration module 52, configured to update and configure the uplink subframe, or, the uplink subframe and the idle subframe to a downlink subframe, so as to receive the updated system information transmitted by the access network equipment in a system information window corresponding to the above identifier; and

a receiving module 53, configured to receive the updated system information transmitted by the access network equipment on all subframes in the system information window corresponding to the identifier.

For example: in order not to influence uplink data transmission and downlink data transmission of the user equipment supporting a full duplex data transmission mode, in particular, when the user equipment is the one supporting a half duplex data transmission mode, the determining module 51 can determine the uplink subframe being included, or the uplink subframe and the idle subframe being included, in the system information window corresponding to the identifier.

According to the present embodiment, the user equipment receives via the indication receiving unit the indication information broadcasted by the access network equipment, where the above indication information is configured to indicate the identifier of the updated system information, so that the information receiving unit can receive the updated system information transmitted by the above access network equipment in the system information window corresponding to the identifier, which is capable of avoiding problems that the user equipment is unable to correctly receive the updated system information in that, in the prior art, the subframe, configured by the user equipment supporting the half duplex data transmission mode in the system information receiving window corresponding to the updated system information, may include the uplink subframe or further include the idle subframe, thus enhancing reliability of acquiring system information and reliability of data transmission.

In addition, according to another embodiment of the present invention, after the information receiving unit 42 has finished receiving the updated system information transmitted by the above access network equipment in the system information window corresponding to the identifier, the configuration module 52 in particular may restore and configure the updated and configured downlink subframe to the uplink subframe, or to the uplink subframe and the idle subframe, so as to reduce influence on the data transmission efficiency for the user equipment as much as possible.

A person having ordinary skill in the art may explicitly aware that, for the purpose of convenient and concise description, with regard to the specific working process of the system, apparatus, and unit being set forth above, the corresponding process according to the previous method embodiments may be referred to. Herein no tautology is necessary.

According to several embodiments provided by the present application, it should be understood that the disclosed system, device and method can be implemented by other means. For example, the aforementioned device embodiments are merely illustrative, e.g., the partition of the units are solely logical function partitions, when being implemented in practice, there may be other partition means, such as a plurality of units or components can be combined or be integrated into another system, or some features can be ignored or are not executed. Another point is, the disclosed or discussed couplings, direct couplings or communication connections between one and another may be indirect couplings or communication connections via some interfaces, devices, or units; they may be in an electrical form, a mechanical form, or other forms.

The units illustrated as separated components may or may not be physically separated, and the components illustrated as units may or may not be physical units, i.e., they may be located at one place, or may be distributed to a plurality of network units. It is possible to select part of or all units thereof to meet the ends of the solutions of the embodiments in view of actual demand.

Moreover, in each embodiment of the present invention, each function unit can be integrated into one processing unit, each unit can be physically existed separately, or two or more than two units are integrated into one unit. The above integrated units can be implemented either in a hardware form or in a hardware plus software function unit form.

The aforementioned integrated units being implemented in a software function unit form can be stored in a computer readable storage medium. The aforementioned software function unit can be stored in a storage medium, comprising many instructions configured to enable one computer device (which can be a personal computer, a server, a network device, etc) to execute some steps of the method according to each embodiment of the present invention. The aforementioned storage medium includes: media capable of storing programming codes such as a USB disk, a mobile hard drive, a read-only memory (Read-only Memory, ROM), a random access memory (Random Access Memory, RAM), a magnetic disk, or an optical disc.

At length, it shall be set forth: the above embodiments are merely to set forth the technical solutions for the prevent invention, instead of limitation thereto; even though the present invention has been elaborated with reference to the aforementioned embodiments, a person having ordinary skill in the art shall understand: modifications to the technical solutions described in each embodiment aforementioned, or substitutions of partial technical features thereof may still be made; nevertheless, the modifications and substitutions shall not enable the gist of the corresponding technical solutions to deviate from the spirit and scope of the technical solutions for each embodiment of the present invention.

1. A method for updating system information, comprising:
determining, by an access network equipment, updated system information; and
broadcasting, by the access network equipment, indication information wherein the indication information is configured to indicate an identifier of the updated system information so that, in a system information window corresponding to the identifier, a user equipment receives the updated system information transmitted by the access network equipment.

2. The method according to claim 1, wherein broadcasting, by the access network equipment, the indication information further comprises:
broadcasting, by the access network equipment, a paging message that comprises the indication information.

3. A method for updating system information, comprising:
receiving, by a user equipment, indication information broadcast by an access network equipment, wherein the indication information is configured to indicate an identifier of updated system information; and
receiving, by the user equipment, the updated system information transmitted by the access network equipment in a system information window corresponding to the identifier.

4. The method according to claim 3, wherein receiving, by the user equipment, the indication information broadcast by the access network equipment comprises:
receiving, by the user equipment, a paging message broadcast by the access network equipment, wherein the paging message comprises the indication information.

5. The method according to claim 3, wherein receiving, by the user equipment, the updated system information transmitted by the access network equipment, in the system information window corresponding to the identifier, comprises:
determining, by the user equipment, an uplink subframe, or, an uplink subframe and an idle subframe, being included in the system information window corresponding to the identifier;
updating and configuring, by the user equipment, the uplink subframe, or, the uplink subframe and the idle subframe, to a downlink subframe; and
receiving, by the user equipment on each subframe in the system information window that corresponds to the identifier, the updated system information transmitted by the access network equipment.

6. The method according to claim 5, wherein determining, by the user equipment, the uplink subframe, or, the uplink subframe and the idle subframe, being included in the system information window corresponding to the identifier comprises:
when the user equipment supports a half duplex data transmission mode, determining, by the user equipment, the system information window corresponding to the identifier includes the uplink subframe, or the uplink subframe and the idle subframe.

7. The method according to claim 5, wherein, after the user equipment on each subframe in the system information window that corresponds to the identifier receives the updated system information transmitted by the access network equipment, the method further comprises:
restoring and configuring, by the user equipment, the updated and configured downlink subframe to the uplink subframe, or the uplink subframe and the idle subframe.

8. An access network equipment, comprising:
a determining unit, configured to determine updated system information; and
a broadcasting unit, configured to broadcast indication information, wherein the indication information is configured to indicate an identifier of the updated system information determined by the determining unit so that, in a system information window corresponding to the identifier, a user equipment receives the updated system information transmitted by the access network equipment.

9. The access network equipment according to claim 8, wherein the broadcasting unit is configured to:
broadcast a paging message that comprises the indication information.

10. A user equipment, comprising:
an indication receiving unit, configured to receive indication information broadcast by an access network equipment, wherein the indication information is configured to indicate an identifier of updated system information; and
an information receiving unit, configured to receive the updated system information transmitted by the access network equipment in a system information window corresponding to the identifier being indicated by the indication information received by the indication receiving unit.

11. The user equipment according to claim 10, wherein the indication receiving unit is configured to:
receive a paging message broadcast by the access network equipment, wherein the paging message comprises the indication information.

12. The user equipment according to claim 10, wherein the information receiving unit comprises:
a determining module, configured to determine an uplink subframe, or, an uplink subframe and an idle subframe, being included in the system information window corresponding to the identifier;
a configuration module, configured to update and configure the uplink subframe, or, the uplink subframe and the idle subframe, to a downlink subframe, so as to receive the updated system information transmitted by the access network equipment in the system information window corresponding to the identifier being indicated by the indication information received by the indication receiving unit; and
a receiving module, configured to receive the updated system information transmitted by the access network equipment on each subframe in the system information window that corresponds to the identifier being indicated by the indication information received by the indication receiving unit.

13. The user equipment according to claim 12, wherein the determining module is configured to:
when the user equipment supports a half duplex data transmission mode, determine the system information window corresponding to the identifier being indicated by the indication information received by the indication receiving unit includes the uplink subframe, or the uplink subframe and the idle subframe.

14. The user equipment according to claim 12, wherein the configuration module is configured to:
restore and configure the updated and configured downlink subframe to the uplink subframe, or the uplink subframe and the idle subframe.
